(19) United States
(12) Patent Application Publication
(10) Pub. No.: US 2026/0309212 A1
(43) Pub. Date: Oct. 8, 2026

(54) LEAD SCREW TRANSMISSION SUPPORT SYSTEM CAPABLE OF SUPPRESSING DEFORMATION AND CONTROL METHOD

(71) Applicant: DALIAN UNIVERSITY OF TECHNOLOGY, Dalian (CN)

(72) Inventors: Zhi WANG, Dalian (CN); Hongwei SUN, Dalian (CN); Qingkai JIANG, Dalian (CN); Fuyan SUN, Dalian (CN); Feilong GU, Dalian (CN)

(21) Appl. No.: 19/347,058

(22) Filed: Oct. 1, 2025

(30) Foreign Application Priority Data
Jul. 31, 2025 (CN) 202511065427.4

(51) Int. Cl. F16H 25/24; F16H 57/04

(52) U.S. Cl. CPC F16H 25/24; F16H 57/0497

(57) ABSTRACT

The present invention belongs to the field of precision control of lead screw transmission systems in computer numerical control machine tools, and discloses a lead screw transmission support system capable of suppressing deformation and a control method. A lead screw transmission support system capable of suppressing deformation comprises a machine bed, a left fixing support of a lead screw, sliding tables, a rotating nut, a right fixing support of the lead screw, a long lead screw, a guide rail support system and a lead screw transmission support unit. The present invention provides auxiliary supports for the long lead screw in the lead screw transmission support system for resisting the bending deformation caused by gravity, thereby enhancing the transmission precision of the lead screw transmission support system and alleviating the poor state of noise and vibration in the system.

### TECHNICAL FIELD

The present invention belongs to the field of precision control of lead screw transmission systems in computer numerical control machine tools, and relates to a lead screw transmission support system capable of suppressing deformation and a control method.

### BACKGROUND

In recent years, as core components of products in industries such as aerospace, shipbuilding, etc. begin to be manufactured domestically, the demands for large machine tools have been gradually increasing. In combination with the processing demands for various ultra-long structural components, high-precision computer numerical control machine tools with ultra-long strokes become urgently needed industrial machine tools. The control capabilities of precision, temperature, noise, etc. of the lead screw transmission system as one of the most crucial functional components for achieving ultra-long strokes in the computer numerical control machine tools determine the comprehensive performance of motion of the machine tools. For medium and small-sized machine tools, the size and the length of the common lead screw transmission system are small. The deformation of the lead screw caused by dead weight is generally controlled by a pre-stretching method. In large machine tools, the lead screw transmission system generally adopts a large and ultra-long nut rotating lead screw with large diameter and large support span to satisfy the large stroke demand for linear axis movement in the large machine tools. The ultra-long lead screw of this type of transmission system is stationary, and one of the core technical points affecting the precision of the ultra-long lead screw by driving a nut to rotate is the dead-weight bending deformation of the lead screw transmission system. When the bending deformation is severe, the motion error and the precision stability of a moving component driven by the lead screw are poor, thereby affecting the noise, the temperature rise and lead screw life of lead screw transmission. Therefore, suppressing the deformation amount of the long-lead screw transmission system and adopting an appropriate control method are essential conditions for ensuring the motion precision and stability of the large machine tools.

At present, the common control method for the dead weight deformation of the lead screw is the following auxiliary support. A support mechanism is installed on a moving component and follows a sliding table to move. For example, as described in the paper “High-Precision Lead Screw Support Device for Ensuring High Movement Speed of Feed Shaft” published by Yu Peng of Shenyang Zhongjie Machine Tool Co., Ltd., when the lead screw rotates and drives a nut to drive a sliding plate to move horizontally along the axial direction of the lead screw, the sliding plate collides with impact blocks on both sides of the inner wall of a lead screw support seat, thereby driving the lead screw support device other than the guide rail to move horizontally to achieve dynamic support for the lead screw. This type of lead screw support solution has certain effects when applied to medium, short and long lead screws and lead screw rotating drive solutions, can only provide local support in ultra-long lead screws, and has poor full-stroke deformation support effect.

The present invention proposes a lead screw transmission support system capable of suppressing deformation and a control method in combination with the characteristics of the application and the technical demands of machine tools, and ensures the precision, reliability and stability of precision transmission of the lead screws in large machine tools.

### SUMMARY

To solve the above problems in the prior art, the present invention provides a lead screw transmission support system capable of suppressing deformation and a control method. The support system comprises two support units, as shown in support 1 and support 2 in FIG. 1. In linear motion, the support units serve as auxiliary supports for the lead screw. Through the effective control of a computer numerical control system and a hydraulic station for the support system, the bending deformation caused by the dead weight of the lead screw is reduced.

The technical solution of the present invention is as follows:

A lead screw transmission support system capable of suppressing deformation comprises a machine bed 1, a left fixing support 2 of a lead screw, sliding tables 5, a rotating nut 6, a right fixing support 7 of the lead screw, a long lead screw 8, a guide rail support system 9 and a lead screw transmission support unit.

An upper surface of the machine bed 1 is a guide rail installation surface on which the guide rail support system 9 is installed, and sliding tables 5 are installed on the guide rail support system 9; the long lead screw 8 penetrates through the sliding tables 5, and both ends of the long lead screw 8 are fixedly installed on the machine bed 1 by the left fixing support 2 of the lead screw and the right fixing support 7 of the lead screw respectively; the rotating nut 6 is installed between the sliding tables 5 and the long lead screw 8; and by driving the rotating nut 6 through a motor, the sliding tables 5 move along the direction of a guide rail.

The lead screw transmission support unit is arranged below the long lead screw 8.

The lead screw transmission support unit comprises a lead screw support nylon block 10, a telescopic rod 11, a linear bearing 12, a support cylinder body 13, a hydraulic bar 14, position sensors 15 and a position detection rod 16.

An extension rod of the hydraulic bar 14 is connected with one end of the telescopic rod 11, and the other end of the telescopic rod 11 is connected with the lead screw support nylon block 10; the telescopic rod 11 and the support cylinder body 13 perform positioning motion through the linear bearing 12; the position detection rod 16 is directly connected with the telescopic rod 11 and performs synchronous telescopic actions; and two position sensors 15 are configured on the hydraulic bar 14 to detect extended and retracted positions.

The hydraulic bar 14 is a one-in one-return reversible oil cylinder; the hydraulic bar 14 is connected with an oil supply system; the oil supply system is connected with a hydraulic station; a hydraulic station control system is connected with a computer numerical control system of a machine tool; and the telescopic rod 11 is controlled by setting a corresponding program.

A control method of the lead screw transmission support system capable of suppressing deformation for suppressing lead screw deformation comprises the following steps:
controlling the oil supply amount and the oil supply speed of the hydraulic bar 14 and the reversal of an oil supply cavity in the lead screw transmission support unit according to a positional relationship among the sliding tables 5, the machine bed 1 and the lead screw transmission support unit to control the extension and retraction of the telescopic rod 11, and further applying a gravitational reverse force to the long lead screw 8 at a set position to resist deformation caused by gravity to achieve the purpose of reducing gravitational deformation amount to provide a safe and reliable method for suppressing deformation.

The present invention has the following beneficial effects: the present invention provides auxiliary supports for the lead screw in the lead screw transmission support system for resisting the bending deformation caused by gravity, thereby enhancing the transmission precision of the transmission system and alleviating the poor state of noise and vibration in the system. The lead screw transmission support system of the present invention is conducive to the use effect of a long lead screw solution in the ultra-long computer numerical control machine tools and provides a new support solution for the lead screw transmission system of the large machine tools.

### DESCRIPTION OF DRAWINGS

FIG. 1 is an arrangement diagram of a lead screw transmission support system.

FIG. 2 is a structural diagram of a lead screw transmission support unit.

FIG. 3 is an explanation diagram of a control method of a lead screw transmission support system.

In the figures: 1—machine bed; 2—left fixing support of lead screw; 3—first lead screw transmission support unit; 4—second lead screw transmission support unit; 5—sliding table; 6—rotating nut; 7—right fixing support of lead screw; 8—long lead screw; 9—guide rail support system; 10—lead screw support nylon block; 11—telescopic rod; 12—linear bearing; 13—support cylinder body; 14—hydraulic bar; 15—position sensor; 16—position detection rod.

### DETAILED DESCRIPTION

Detailed description of the present invention is described below in detail in combination with drawings and the technical solution.

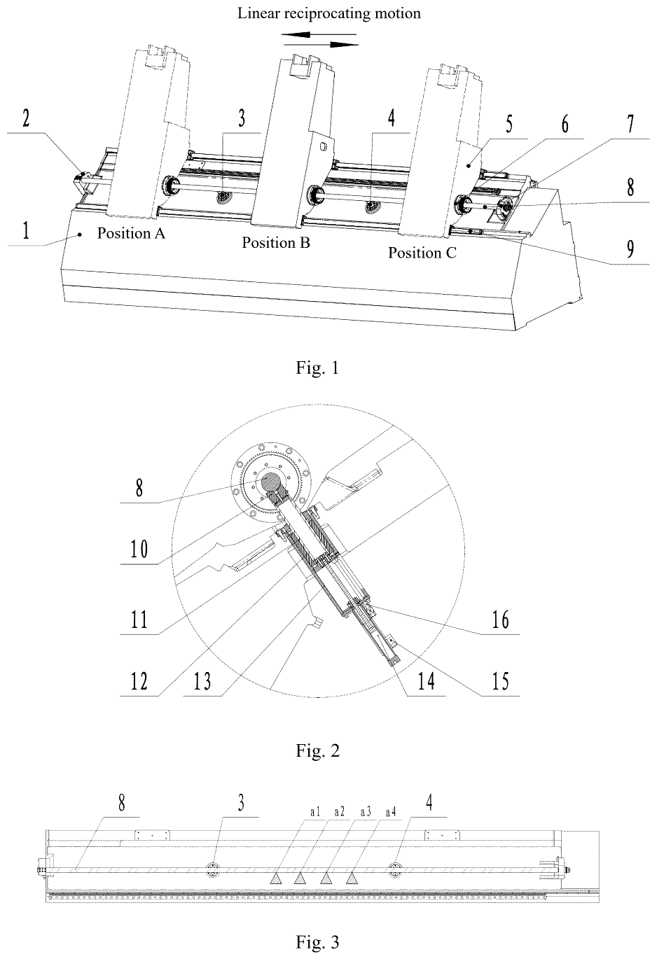

The present invention provides a lead screw transmission support system capable of suppressing deformation and a control method. The arrangement diagram of the lead screw transmission support system in lead screw transmission application is shown in FIG. 1, the structural diagram of the lead screw transmission support unit is shown in FIG. 2, and the control method of the lead screw transmission support system is shown in FIG. 3. The lead screw transmission support system provides auxiliary support for the lead screw during motion, suppresses the gravitational bending deformation of the lead screw, and improves the performance of motion precision, stability, noise, etc. of the moving component.

A lead screw transmission support system capable of suppressing deformation is provided, and the lead screw transmission support unit is arranged in the lead screw transmission system. The lead screw transmission system applicable to the present invention has the characteristic of a lead screw with an ultra-long stroke, generally over three meters. Both ends of the long lead screw 8 are fixedly installed on the machine bed 1 of a machine tool by the left fixing support 2 of the lead screw and the right fixing support 7 of the lead screw through screws; the long lead screw 8 with a rotating nut 6 is installed in the sliding tables 5 by flange screws; and the rotating nut 6 is driven to rotate by a motor to achieve the motion of the sliding tables 5. Due to the excessive length of the long lead screw 8, after both ends are fixed and supported, a bending deformation amount is formed under the effect of gravity, resulting in poor precision after installation of the long lead screw 8. Different numbers of lead screw transmission support units are arranged according to long lead screws 8 with different lengths. The present invention takes a transmission system of a 5-meter long lead screw 8 as an example. A first lead screw transmission support unit 3 and a second lead screw transmission support unit 4 are arranged below the long lead screw 8, and the two lead screw transmission support units have the same structures. The lead screw transmission support units are installed on the machine bed 1 by screws and connected with a hydraulic station of the machine tool. The hydraulic station and a solenoid valve are controlled by the computer numerical control system, thereby achieving the action control of the lead screw transmission support units.

The assembly relationship of the lead screw transmission support units is as follows:

An extension rod of a hydraulic bar 14 is connected with one end of a telescopic rod 11 through a screw thread, and the other end of the telescopic rod 11 is connected with a lead screw support nylon block 10 through a screw. A piston rod that performs telescopic actions can be achieved by the above composition. The support cylinder body 13 fixedly connects the lead screw transmission support units and the machine bed 1 through screws to provide support forces for the lead screw transmission support units. A linear bearing 12 is embedded into the support cylinder body 13 to support and position the telescopic rod 11. A position detection rod 16 and the telescopic rod 11 are connected as a whole and perform telescopic actions synchronously. The hydraulic bar 14 has two stroke cavities, an extended oil supply cavity and a retracted oil supply cavity which are connected with the solenoid valve and the hydraulic station through hydraulic pipes. Two position sensors 15 are installed on the outer wall of the hydraulic bar 14. When the position detection rod 16 performs extension and retraction actions, the position sensors 15 output the limit position signals of two actions.

A control method of the lead screw transmission support system for suppressing deformation is as follows:

As shown in FIG. 1 and FIG. 3, the sliding tables 5 need to be driven by the long lead screw 8 to perform linear reciprocating motion, that is, to move from position A to position C and then from position C to position A. The installation positions of the two lead screw transmission support units are within the stroke range. When the sliding tables 5 move from position A to position C and are at position A, the first lead screw transmission support unit 3 retracts, and the second lead screw transmission support unit 4 extends; when the sliding tables 5 pass through the first lead screw transmission support unit 3 and reaches position a1, the first lead screw transmission support unit 3 extends out; at this time, the two lead screw transmission support units are in an extended state; when the sliding tables 5 reach position a2, the second lead screw transmission support unit 4 retracts; at this time, the first lead screw transmission support unit 3 remains in an extended state; when the sliding tables 5 pass through the second lead screw transmission support unit 4, the two lead screw transmission support units still remain in a state where the first lead screw transmission support unit 3 extends and the second lead screw transmission support unit 4 retracts; when the sliding tables 5 reach position C, the two lead screw transmission support units remain unchanged; when the sliding tables 5 start to move in reverse from position C to position A, when the sliding tables 5 pass in reverse through the position of the second lead screw transmission support unit 4, the states of the two lead screw transmission support units remain unchanged; when the sliding tables 5 reach position a4, the second lead screw transmission support unit 4 extends; when the sliding tables 5 reach position a3, the first lead screw transmission support unit 3 retracts, and the two lead screw transmission support units remain in this state; and until the sliding tables 5 move to position A, the above cyclic action is repeated.

The present invention uses a new lead screw support structural form, and achieves reverse suppression of the gravitational bending deformation of the ultra-long lead screw in combination with the specific motion control method, thereby ensuring assembly precision of the lead screw in a free state. The method enhances the transmission precision and rigidity of the lead screw, and improves dynamic performance of vibration, temperature rise, etc. The application of the present invention to ultra-large turning and milling composite computer numerical control machine tools better improves the demands for high-precision performance of lead screw transmission.

1. A lead screw transmission support system capable of suppressing deformation, comprising a machine bed, a left fixing support of a lead screw, sliding tables, a rotating nut, a right fixing support of the lead screw, a long lead screw, a guide rail support system and a lead screw transmission support unit; wherein
an upper surface of the machine bed is a guide rail installation surface on which the guide rail support system is installed, sliding tables are installed on the guide rail support system; the long lead screw penetrates through the sliding tables, and both ends of the long lead screw are fixedly installed on the machine bed by the left fixing support of the lead screw and the right fixing support of the lead screw respectively; the rotating nut is installed between the sliding tables and the long lead screw; and by driving the rotating nut through a motor, the sliding tables move along the direction of a guide rail;
the lead screw transmission support unit is arranged below the long lead screw.

2. The lead screw transmission support system according to claim 1, wherein
the lead screw transmission support unit comprises a lead screw support nylon block, a telescopic rod, a linear bearing, a support cylinder body, a hydraulic bar, position sensors and a position detection rod;
an extension rod of the hydraulic bar is connected with one end of the telescopic rod, and the other end of the telescopic rod is connected with the lead screw support nylon block; the telescopic rod and the support cylinder body perform positioning motion through the linear bearing; the position detection rod is directly connected with the telescopic rod and performs synchronous telescopic actions; and two position sensors are configured on the hydraulic bar to detect extended and retracted positions.

3. The lead screw transmission support system according to claim 2, wherein
the hydraulic bar is a one-in one-return reversible oil cylinder; the hydraulic bar is connected with an oil supply system; the oil supply system is connected with a hydraulic station; a hydraulic station control system is connected with a computer numerical control system of a machine tool; and the telescopic rod controlled by setting a corresponding program.

4. A control method of the lead screw transmission support system capable of suppressing deformation for suppressing lead screw deformation, comprising the following steps:
controlling the oil supply amount and the oil supply speed of the hydraulic bar and the reversal of an oil supply cavity in the lead screw transmission support unit according to a positional relationship among the sliding tables, the machine bed and the lead screw transmission support unit to control the extension and retraction of the telescopic rod, and further applying a gravitational reverse force to the long lead screw at a set position to resist deformation caused by gravity to achieve the purpose of reducing gravitational deformation amount to provide a safe and reliable method for suppressing deformation.
